(19) United States
(12) Patent Application Publication
(10) Pub. No.: US 2023/0181415 A1
(43) Pub. Date: Jun. 15, 2023

(54) Ultrasonic Fluid Pump for Lymphedema

(71) Applicant: BOARD OF TRUSTEES OF THE UNIVERSITY OF ARKANSAS, Fayetteville, AR (US)

(72) Inventors: Steven Jacob Mahaffey, Stillwater, OK (US); Paul Krautter, Tulsa, OK (US)

(73) Assignee: BOARD OF TRUSTEES OF THE UNIVERSITY OF ARKANSAS, Fayetteville, AR (US)

(21) Appl. No.: 18/080,687

(22) Filed: Dec. 13, 2022

Related U.S. Application Data
(60) Provisional application No. 63/289,065, filed on Dec. 13, 2021.

(51) Int. Cl. A61H 9/00

(52) U.S. Cl. CPC A61H 9/0092

(57) ABSTRACT

A method and device that provides an improved way to treat lymphedema. An ultrasonic fluid pump including speakers attached to a flexible material stocking, combined with a controller, which is adapted to control the operation of the speakers to enable the speakers to cause fluid to flow in a predetermined direction.

### RELATED APPLICATIONS

This application claims priority to U.S. Provisional Application No. 63/289,065, filed on Dec. 13, 2021, which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Hermon Helmholtz was the founding physiologist who discovered the concept regarding a voltage created by suspended partials. This is known as the zeta potential as shown in the adjacent figure (also attached larger at the end of the document). This force is created due to electrostatic participles held in solution. It is this understanding of electrical properties of colloidal suspensions which underpins this innovation. Piezoelectric fans give understanding that this concept would work well1. However, this innovation has a different mechanism of action than piezoelectric fans. Piezoelectric electric fans have a membrane like fan blade that moves back and forth that pushes the air. The proposed innovation would not have a blade which is used in piezoelectric fans, but instead would use the direct energy from the current to create fluid movement.

### BRIEF SUMMARY OF THE INVENTION

In one embodiment, the present invention provides a method and device that provide an improved way to treat lymphedema. The two mainstays of treatment are compression stockings and sequential compression devices are currently inadequate, and the device is proposed to resolve this problem.

In other embodiments, the present invention provides a device that is more comfortable which should result in increased patient compliance. This device is intended to only be worn for a short period of time unlike compression stockings; this should further enhance patient satisfaction and compliance.

Another problem with compression stockings is that they may cause pressure ulcers. Since this device is only worn for a short period of time it is proposed to not create compression ulcers.

In other aspects, the present invention will have improved efficacy over sequential compression devices. It will operate at ultrasonic frequencies which provide 1000 fold fluid movement increases over the sequential compression devices which uses a very low frequency. An example of implementation of the proposed device would be to create pulsating movement 20,000 times a second, whereas the VTE prophylaxis device can only create one sequential movement per several minutes.

In one embodiment, the present invention concerns an ultrasonic fluid pump comprising: a plurality of speakers attached to a flexible material; the flexible material in the form of a stocking; and a controller, the controller is adapted to control the operation of the speakers such that the speakers cause fluid to flow in a predetermined direction in a patient.

In another embodiment, the present invention concerns an ultrasonic fluid pump wherein the speakers are operated by the controller to create a sequential pulsation.

In another embodiment, the present invention concerns an ultrasonic fluid pump wherein the speakers are arranged in plurality of rings and the controller is to adapted to sequentially activate each speaker one at a time in a ring before activating an adjoining ring of speaker sequentially one at a time.

In another embodiment, the present invention concerns an ultrasonic fluid pump wherein the speakers in a ring are 120 degrees apart.

In another embodiment, the present invention concerns an ultrasonic fluid pump wherein the speakers are operated in phase with one another which creates a fluid wave front which pushes the fluid in a single direction.

In another embodiment, the present invention concerns an ultrasonic fluid pump the speakers are operated in phase with one another which creates a fluid wave front which pushes the fluid in a single direction.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows an embodiment of the present invention.

FIG. 2 illustrates an embodiment of the present invention placed on a patient.

FIG. 3 illustrates another embodiment of the present invention.

FIG. 4 shows an embodiment of the present invention wherein the speakers are arranged in rings.

FIG. 5 shows another embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

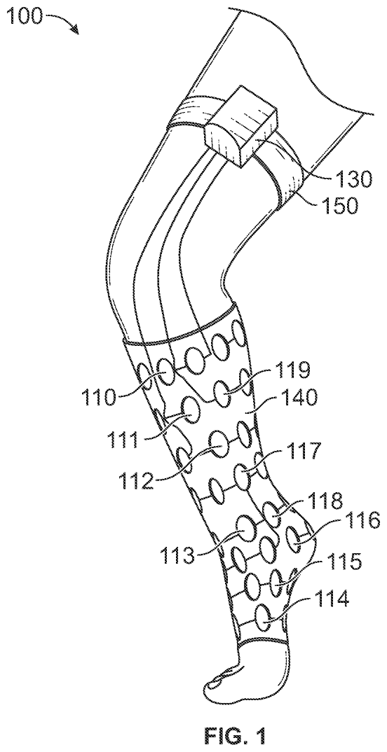

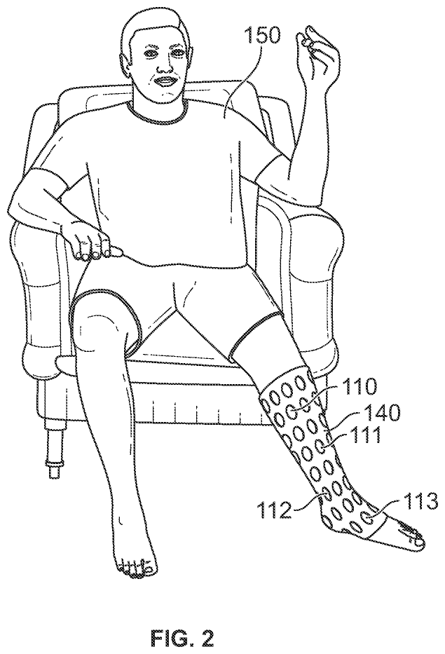

In one embodiment, as shown in FIGS. 1 and 2, the present invention provides an ultrasonic fluid pump 100 comprising a plurality speakers 110-119 controlled by controller 130. Speakers 110-119 are embedded or attached to a flexible material 140. The flexible material may be in the form of a sock or stocking shaped to fit over s patient's foot and lower leg. Ultrasonic fluid pump 100 is adapted to move the fluid in patient 150.

In another embodiment, flexible material may be nylon netting with elastic. This would be elastically fit to the shape of the leg. This elastic would not exert any pressure but would have sufficient elasticity to prevent it from falling off a patient.

The present invention may be either worn for extended periods of time or intermittently. If worn for an extended period of time, the low level of pressure a comfortable fit with a patient allowing a patient to easily perform activities of daily living. The low 20 mm profile of the speakers would allow the patient to easily slip a shoe over the device 1.

A preferred embodiment uses piezoelectric speakers to create sound waves needed to move the fluid. The speakers may be in the form of flat discs which are fixated to the stocking.

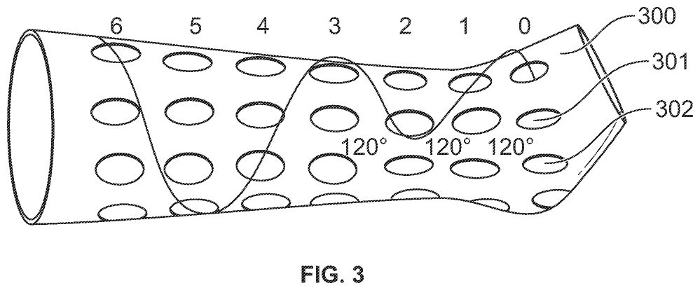

Piezoelectric speakers may be used to create the sound waves required to move the fluid. The speakers, which may be flat discs, may be attached to the stocking in linear rows 300-302 as shown in FIG. 3. Herein, row 0 produces a wave form first, then row 1, then row 2, and so on. To create this sequential pulsation a circuit producing separate signals of pulsations slightly out of phase with each other connect to the speakers.

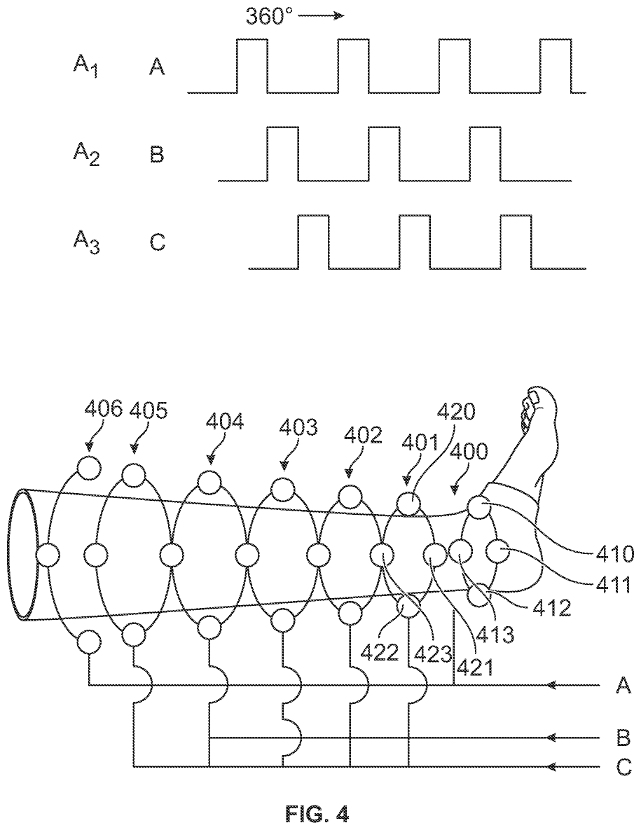

An example of a way to produce a waveform of sound with continuous pressure in a single direction is shown in FIG. 4. In this embodiment, speakers in Row A are 120 degrees out of phase with the speakers in Row B and the speakers in Row C are 120 degrees out of phase with the speakers in Row B. This creates a synchronous phase adjusted waveform as shown in FIG. 4.

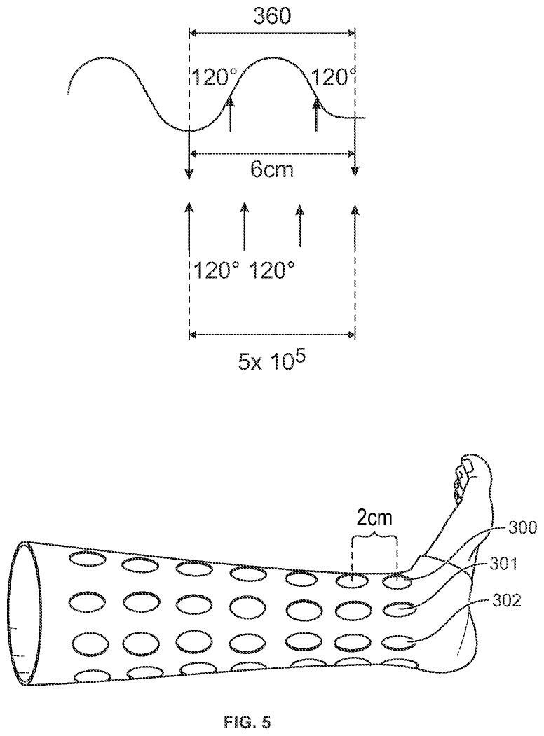

The speakers would have the same frequency, but phase adjusted to synchronize with the wave front. A 6 cm wavelength divided into three phases would mean 2 cm of separation would continually reinforce the same wavefront. Thus, the speakers in rows 300-302 are spaced 2 cm apart as shown in FIGS. 3 and 5.

In another embodiment, as shown in FIG. 4, the speakers are arranged in rings 400-406 that encircle a patient's leg. As shown, ring 400 is comprised of a plurality of speakers 410-413. Next, adjoining ring 401 is comprised of a plurality of speakers 420-423. This arrangement is repeated along the length of the stocking until ring 406.

In operation, to drive fluid in a single direction, each speaker in a ring is activated one at a time until all speakers in a ring are activated, and at this time, the same sequentially pulsing is performed for the next adjoining ring. An exemplary activation sequence is as follows: ring 400—speaker 410 is turned on then off, speaker 411 is turned on then off, 412 is turned on then off, and then speaker 413 is turned on then off. Once speaker 413 is turned off the speakers in ring 401 are activated as flows: speaker 420 is turned on then off, speaker 421 is turned on then off, 422 is turned on then off, and then speaker 423 is turned on then off. This process is repeated up to ring 406 and then may be repeated starting with ring 400 again as often as desired.

The following formula shows how the movement is presumed to be most effective:

Frequency=velocity/wavelength

20,000 Hz frequency=1200 m/s/6 cm,

Thus, this leaves 16.7 microseconds between each sound wave production of sequential speakers. The speakers would be in phase with one another which creates a fluid wave front which pushes the fluid in a single direction thereby resolving the edema.

From a physiologic perspective, the fluid is pushed into a more proximal interstitial space and then into lymphatics, then into the vascular system. Thereafter the renal system excretes the excess fluid from the patient's body.

Since arterial flow goes down the deep tissues of the leg and edema occurs primarily in the superficial layers, the radio dissipation of wound intensity as it travels into deeper tissues suggest that this waveform would treat the outside of the leg without harming the inner part of the leg, thereby not affecting arterial blood flow. This aspect should allow for the treatment of edema while not effecting arterial flow. Since the patients with edema often have vascular comorbidity, this property would be an important advantage to increasing the efficacy of the device.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. An ultrasonic fluid pump comprising: a plurality of speakers attached to a flexible material; said flexible material in the form of a stocking; and a controller, said controller adapted to control the operation of said speakers such that said speakers cause fluid to flow in a predetermined direction in a patient.

2. The ultrasonic fluid pump of claim 1 wherein said speakers are operated by said controller to create a sequential pulsation.

3. The ultrasonic fluid pump of claim 1 wherein said speakers are arranged in plurality of rings and said controller is to adapted to sequentially activate each speaker one at a time in a ring before activating an adjoining ring of speaker sequentially one at a time.

4. The ultrasonic fluid pump of claim 3 wherein said speakers in a ring are 120 degrees apart.

5. The ultrasonic fluid pump of claim 3 wherein said speakers are operated in phase with one another which creates a fluid wave front which pushes the fluid in a single direction.

6. The ultrasonic fluid pump of claim 4 wherein said speakers are operated in phase with one another which creates a fluid wave front which pushes the fluid in a single direction.
